(19) United States
(12) Patent Application Publication
(10) Pub. No.: US 2025/0187582 A1
(43) Pub. Date: Jun. 12, 2025

(54) VEHICLE CONTROL APPARATUS AND METHOD

(71) Applicants: HYUNDAI MOTOR COMPANY, Seoul (KR); KIA CORPORATION, Seoul (KR)

(72) Inventor: Jee Wook Huh, Hwaseong-si (KR)

(73) Assignees: HYUNDAI MOTOR COMPANY, Seoul (KR); KIA CORPORATION, Seoul (KR)

(21) Appl. No.: 18/815,458

(22) Filed: Aug. 26, 2024

(30) Foreign Application Priority Data
Dec. 7, 2023 (KR) 10-2023-0177100

(51) Int. Cl. B60W 20/13; B60W 10/02; B60W 10/06; B60W 10/08; B60W 20/15

(52) U.S. Cl. CPC B60W 20/13; B60W 10/02; B60W 10/06; B60W 10/08; B60W 20/15; B60W 2420/403; B60W 2510/1005; B60W 2510/244; B60W 2540/10; B60W 2540/12

(57) ABSTRACT

A vehicle control apparatus and method are provided. The vehicle control apparatus includes a detector that obtains data using sensors mounted on a vehicle and a processor connected to the detector. The processor determines to enter an in-vehicle rest mode based on the data obtained by the detector, enters the in-vehicle rest mode in a stop state, and controls charging of a battery using a drive motor in the in-vehicle rest mode.

### CROSS-REFERENCE TO RELATED APPLICATION

This application claims the benefit of and priority to Korean Patent Application No. 10-2023-0177100, filed in the Korean Intellectual Property Office on Dec. 7, 2023, the entire contents of which are incorporated herein by reference.

### TECHNICAL FIELD

The present disclosure relates to a vehicle control apparatus and a method thereof.

### BACKGROUND

With the development of autonomous driving technology, a driver may now rest in a vehicle while driving. Thus, the focus of new technology or information technology (IT) is to provide an environment in which the driver may rest in the vehicle while driving. No technological development through vehicle control is being carried out.

Existing vehicle control technology may provide control of suitable resting temperatures when the driver rests or may provide battery charging or the like while stopping. These vehicle control technologies may interfere with the in-vehicle rest of a passenger. For example, noise and vibration generated by repeatedly turning the engine on and off may disturb the sleep of the passenger.

Furthermore, existing vehicle control technologies increase the battery state of charge (SOC) by turning the engine on during long parking time to charge the battery while stopping, which interferes with the in-vehicle rest of the passenger.

### SUMMARY

The present disclosure aims to solve the above-mentioned problems occurring in the prior art while maintaining advantages achieved by the prior art.

Aspects of the present disclosure provide a vehicle control apparatus and method for charging a battery using a drive motor, while a passenger is resting in a vehicle.

Other aspects of the present disclosure provide a vehicle control apparatus and method for controlling a vehicle to minimize an element which hinders a rest of a passenger in the vehicle.

The technical problems to be solved by the present disclosure are not limited to the aforementioned problems. Any other technical problems not mentioned herein should be more clearly understood from the following description by those having ordinary skill in the art to which the present disclosure pertains.

According to an aspect of the present disclosure, a vehicle control apparatus may include a detector that obtains data using sensors mounted on a vehicle and a processor connected to the detector. The processor may determine to enter an in-vehicle rest mode based on the data obtained by the detector. The processor may enter the in-vehicle rest mode in a stop state and may control charging of a battery using a drive motor in the in-vehicle rest mode.

The processor may obtain state information of a user that rides in the vehicle using at least one of a camera or a brain wave sensor, or any combination thereof. The processor may determine whether the user is resting based on the state information of the user and may determine to enter the in-vehicle rest mode based on determining that the user is resting.

The processor may determine to enter a charging control mode based on at least one of whether an accelerator pedal and a brake pedal operate, a gear selector position, or a seat angle, or any combination thereof after entering the in-vehicle rest mode.

The processor may enter an idle charging mode based on a state of charge (SOC) of the battery, may determine a maximum power available for charging based on a maximum power available for charging in an engine in the idle charging mode, and may determine a drive motor maximum power based on a speed of the engine.

The processor may determine a power of the drive motor as the drive motor maximum power, if the maximum power available for charging is greater than the drive motor maximum power. The processor may determine a power of a sub-motor as a power difference between the maximum power available for charging and the drive motor maximum power.

The processor may determine the power of the drive motor as the maximum power available for charging, if the maximum power available for charging is not greater than the drive motor maximum power.

The processor may release a charging control mode based on at least one of state information of a user, whether a brake pedal operates, a gear selector position, or a seat angle, or any combination thereof.

The processor may compensate for a charging power of the drive motor using the maximum charging power of the sub-motor, if the gear selector position switches from a park (P) stage to another gear selector position. The processor may downwardly adjust the charging power of the drive motor and may release an engine clutch, if the charging power of the drive motor reaches “0”.

The processor may downwardly adjust a charging power of the engine and stop the engine.

The processor may compensate for the charging power of the drive motor using the maximum charging power of the sub-motor, if the brake pedal operates.

According to another aspect of the present disclosure, a vehicle control method may include determining to enter an in-vehicle rest mode based on data obtained by a detector mounted on a vehicle, entering the in-vehicle rest mode in a stop state, and controlling charging of a battery using a drive motor in the in-vehicle rest mode.

Determining to enter the in-vehicle rest mode may include obtaining state information of a user that rides in the vehicle, using at least one of a camera or a brain wave sensor, or any combination thereof, determining whether the user is resting based on the state information of the user, and determining to enter the in-vehicle rest mode based on determining that the user is resting.

Entering the in-vehicle rest mode may include determining to enter a charging control mode based on at least one of whether an accelerator pedal and a brake pedal operate, a gear selector position, a seat angle, or any combination thereof after entering the in-vehicle rest mode.

Controlling the charging of the battery may include entering an idle charging mode based on a state of charge (SOC) of the battery, determining a maximum power available for charging based on a maximum power available for charging in an engine in the idle charging mode, and determining a drive motor maximum power based on a speed of the engine.

Controlling the charging of the battery may include determining a power of the drive motor as the drive motor maximum power, if the maximum power available for charging is greater than the drive motor maximum power and may include determining a power of a sub-motor as a power difference between the maximum power available for charging and the drive motor maximum power.

Controlling the charging of the battery may include determining the power of the drive motor as the maximum power available for charging, if the maximum power available for charging is not greater than the drive motor maximum power.

The vehicle control method may further include releasing a charging control mode based on at least one of the state information of a user, whether a brake pedal operates, a gear selector position, a seat angle, or any combination thereof.

Releasing the charging control mode may include compensating for charging power of the drive motor using a maximum charging power of the sub-motor, if the gear selector position switches from a P stage to another gear selector position, downwardly adjusting the charging power of the drive motor, and releasing an engine clutch, if the charging power of the drive motor reaches “0”.

Releasing the charging control mode may further include downwardly adjusting a charging power of the engine and stopping the engine.

Releasing the charging control mode may include compensating for a charging power of the drive motor using a maximum charging power of the sub-motor, if the brake pedal operates.

### BRIEF DESCRIPTION OF THE DRAWINGS

The above and other objects, features, and advantages of the present disclosure should be more apparent from the following detailed description taken in conjunction with the accompanying drawings:

FIG. 1 is a drawing illustrating a configuration of a hybrid electric vehicle (HEV) associated with the present disclosure;

FIG. 2 is a block diagram illustrating a configuration of a vehicle control apparatus according to embodiments of the present disclosure;

FIG. 3 is a flowchart illustrating a vehicle control method according to embodiments of the present disclosure;

FIG. 4 is a flowchart illustrating a method for determining whether an in-vehicle rest mode entry condition is met according to embodiments of the present disclosure;

FIG. 5 is a flowchart illustrating a charging control method using a drive motor according to embodiments of the present disclosure; and

FIG. 6 is a flowchart illustrating a charging control release method using a drive motor according to embodiments of the present disclosure.

### DETAILED DESCRIPTION

Hereinafter, some embodiments of the present disclosure are described in detail with reference to the drawings. In adding the reference numerals to the components of each drawing, it should be noted that identical components are designated by the identical numerals even when they are displayed on different drawings. In addition, a detailed description of well-known features or functions has been omitted in order not to unnecessarily obscure the gist of the present disclosure.

In describing components of embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those of ordinary skill in the art to which the present disclosure pertains. Such terms as those defined in a generally used dictionary are to be interpreted as having meanings consistent with the contextual meanings in the relevant field of art. Such terms are not to be interpreted as having ideal or excessively formal meanings unless clearly defined as having such in the present application. When a component, device, element, or the like of the present disclosure is described as having a purpose or performing an operation, function, or the like, the component, device, or element should be considered herein as being “configured to” meet that purpose or perform that operation or function.

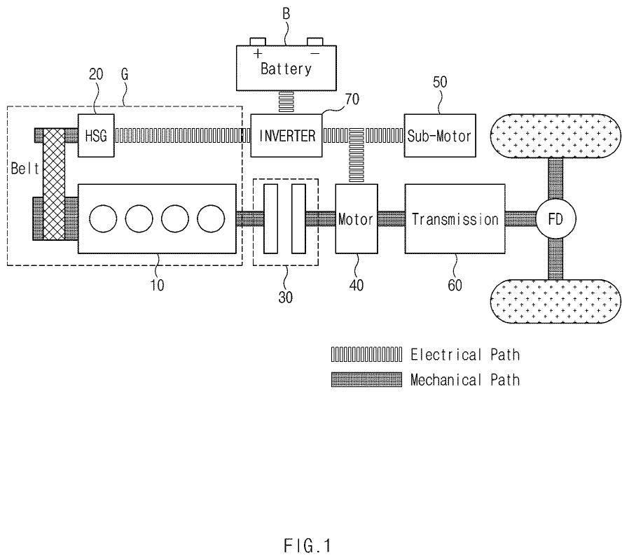

FIG. 1 is a drawing illustrating a configuration of a hybrid electric vehicle (HEV) associated with the present disclosure.

The HEV may refer to a vehicle that uses two or more different types of power sources. In general, the HEV may use an engine to generate power by burning fuel (e.g., gasoline or the like) and a motor to generate power using electrical energy from a battery.

Referring to FIG. 1, the HEV may include an engine 10, a hybrid starter generator (HSG) 20, an engine clutch 30, a drive motor 40, a sub-motor 50, a transmission 60, and an inverter 70.

The engine 10 may burn fuel to generate electric power (or an engine torque) necessary to drive the vehicle. Various well-known engines such as a gasoline engine or a diesel engine may be used as the engine 10. The engine 10 may control an output torque (i.e., an engine torque) under a command of an engine management system (EMS).

The HSG 20 may be connected to the engine 10 by a belt. The HSG 20 may crank the engine 10 to start the engine 10. The HSG 20 may play a role in starting the engine 10 when an electric vehicle mode switches to a hybrid mode. The HSG 20 may operate as a generator which generates electrical energy using electric power of the engine 10 while the engine 10 is running. The electrical energy generated by the HSG 20 may be used to charge a battery B. The HSG 20 and the engine 10 may be collectively referred to as a plant G.

The engine clutch 30 may be disposed between the engine 10 and the drive motor 40 to turn on/off electric power (or an output torque) of the engine 10. The engine clutch 30 may deliver or block electric power (or an engine torque) generated by the engine 10 to drive wheels (or vehicle wheels) by being engaged or disengaged.

The drive motor 40 may receive power from the engine 10 or the inverter 70 to generate electric power (or motor electric power) and may deliver the electric power to the drive wheels. The drive motor 40 may change a rotation direction and a revolution per minute (RPM) under an instruction of a motor control unit (MCU) to control an output torque (or a motor torque) of the drive motor 40. The drive motor 40 may be used as a generator which generates a back electromotive force when there is a lack of a state of charge (SOC) or upon regenerative braking and charges the battery B. The battery B may play a role in supplying power necessary for driving of the vehicle. Furthermore, the battery B may be charged by regenerative energy generated by the drive motor 40. A high voltage battery (or a high-capacity battery) capable of outputting a predetermined high voltage (e.g., 400 V or more) may be applied as the battery B.

The sub-motor 50 may assist the drive motor 40 to charge the battery B while stopping. The sub-motor 50 may charge the battery B by means of a power converter, such as the inverter 70 or a converter, or may directly supply power to the battery B to charge the battery B. The sub-motor 50 may supply necessary power when starting the engine 10.

The transmission 60 may convert the motor torque or the engine torque and the motor torque at a transmission ratio matched with a transmission stage. The transmission 60 may change the transmission stage under an instruction of a transmission control unit (TCU). The TCU may determine an optimal transmission stage based on information such as a driving speed of the vehicle (i.e., a vehicle speed or a wheel speed), an accelerator pedal position, an engine RPM, and/or clutch travel by means of sensors in the vehicle.

The inverter 70 may be a power converter disposed between the drive motor 40 and the battery B and may convert power output from the battery B into motor drive power to supply the motor drive power to the drive motor 40. For example, the inverter 70 may convert a DC voltage output from the battery B into a 3-phase AC voltage necessary to drive the drive motor 40. The inverter 70 may adjust power (e.g., an output voltage) supplied to the drive motor 40 under an instruction of the MCU to control a motor torque. The present embodiment describes an example in which the inverter 70 is disposed between the drive motor 40 and the battery B, but not limited thereto. If the drive motor 40 applied to the vehicle is a DC motor, a converter may be disposed between the drive motor 40 and the battery B or the motor 40 and the battery B may be directly connected with each other without using the power converter.

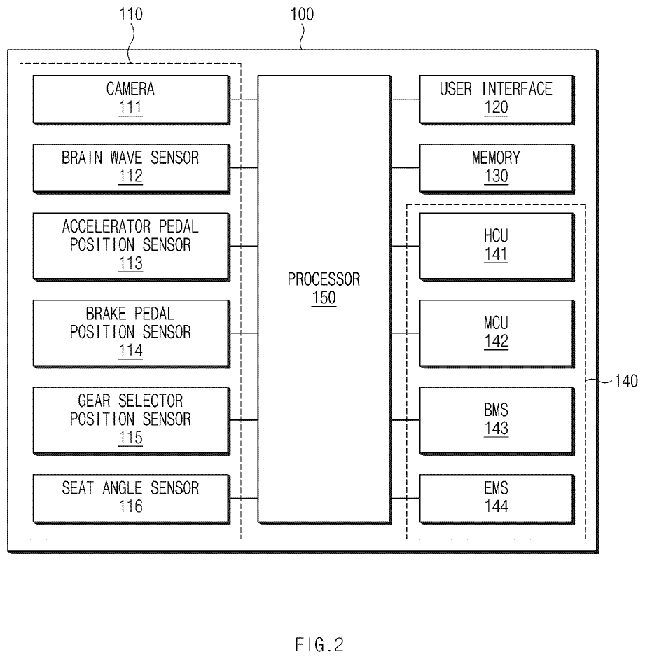

FIG. 2 is a block diagram illustrating a configuration of a vehicle control apparatus according to embodiments of the present disclosure.

A vehicle control apparatus 100 may be loaded into an eco-friendly vehicle (e.g., a hybrid electric vehicle (HEV)) capable of performing autonomous driving. Referring to FIG. 2, the vehicle control apparatus 100 may include a detector 110, a user interface 120, a memory 130, controllers 140, and a processor 150, which are connected through a vehicle network. The vehicle network may be implemented as a controller area network (CAN), a media-oriented systems transport (MOST) network, a local interconnect network (LIN), an Ethernet, X-by-Wire (Flexray), and/or the like.

The detector 110 may sense (or obtain) information of a user (e.g., a driver, a passenger, or the like) that rides in the vehicle using a camera 111, a brain wave sensor 112, and/or the like. The detector 110 may capture the user using the camera 111 and may store the captured image in the memory 130. The camera 111 may include at least one of image sensors, such as a charge coupled device (CCD) image sensor, a complementary metal oxide semi-conductor (CMOS) image sensor, a charge priming device (CPD) image sensor, or a charge injection device (CID) image sensor. The camera 111 may include an image processor for performing image processing, such as noise cancellation, color reproduction, file compression, image quality adjustment, and saturation adjustment, for an image obtained by means of the image sensor. The detector 110 may measure (or detect) a brain wave signal of the user using the brain wave sensor 112. The brain wave sensor 112 may be composed of at least one electroencephalogram (EEG) sensor.

The detector 110 may detect vehicle information using vehicle sensors. The detector 110 may detect a position of an accelerator pedal using an accelerator pedal position sensor 113. The detector 110 may detect a position of a brake pedal using a brake pedal position sensor 114. The detector 110 may detect a gear selector position using a gear selector position sensor 115. Furthermore, the detector 110 may measure a seat angle, which is an inner angle formed by a backrest and a cushion of a seat, using a seat angle sensor 116.

The detector 110 may store data (or information) obtained by the camera 111, the brain wave sensor 112, the accelerator pedal position sensor 113, the brake pedal position sensor 114, the gear selector position sensor 115, the seat angle sensor 116, and/or the like in the memory 130. Furthermore, the detector 110 may directly transmit the data obtained by the camera 111, the brain wave sensor 112, the accelerator pedal position sensor 113, the brake pedal position sensor 114, the gear selector position sensor 115, the seat angle sensor 116, and/or the like to the processor 150.

The user interface 120 may serve to help the vehicle control apparatus 100 and the user to interact with each other. The user interface 120 may include an input device (e.g., a keyboard, a touch pad, a microphone, a touch screen, and/or the like) for generating data according to manipulation of the user, an output device (e.g., a display, a speaker, a tactile signal output device, and/or the like) for outputting information according to an operation of the vehicle control apparatus 100, and/or the like.

The user interface 120 may include a hardware button and/or a software button assigned a function for selecting whether to enter a rest mode. If the button is manipulated by the user, the user interface 120 may output data (or a signal) corresponding to the manipulation of the button. For example, the user interface 120 may transmit data indicating that the rest mode is entered or that the rest mode is ended to the processor 150 depending on the button manipulation of the user.

The memory 130 may be a non-transitory storage medium which stores instructions executed by the processor 150. The memory 130 may include at least one of storage media (or recording media), such as a flash memory, a hard disk, a solid-state disk (SSD), a secure digital (SD) card, a random access memory (RAM), a static RAM (SRAM), a read only memory (ROM), a programmable ROM (PROM), an electrically erasable and programmable ROM (EEPROM), or an erasable and programmable ROM (EPROM).

The memory 130 may store an in-vehicle rest control algorithm, an image analysis algorithm, a brain wave analysis algorithm, and/or the like. The memory 130 may store information (or setting information) preset by a system designer and/or the user. The memory 130 may store input data and/or output data of the processor 150.

The controllers 140 may operate based on data (or a control command) transmitted from the processor 150. Furthermore, the controllers 140 may obtain data (or information) requested by the processor 150 and may transmit the obtained data to the processor 150. The controllers 140 may transmit and receive data with each other.

The controllers 140 may be electronic control units mounted on the vehicle, which may include a hybrid control unit (HCU) 141, a motor control unit (MCU) 142, a battery management system (BMS) 143, an engine management system (EMS) 144, and/or the like.

The HCU 141 may control the overall operation (e.g., motor start, idle stop, engine stop upon brake stop, or the like) of the vehicle.

The MCU 142 may control a rotational direction, a rotational speed, and the like of the drive motor 40 and/or the sub-motor 50. The MCU 142 may control output power and/or torque (s) of the drive motor 40 and/or the sub-motor 50.

The BMS 143 may monitor SOCs, voltages, currents, temperatures, and/or the like of a high voltage battery and a low voltage battery. The BMS 143 may prevent the battery from being overcharged when charging the battery and may prevent the battery from being over-discharged when discharging the battery, thus managing an SOC of the battery.

The EMS 144 may be a system which controls and manages the engine 10, which may turn on (or operate) or turn off (or stop) the engine 10. The EMS 144 may control an output torque of the engine 10.

The processor 150 may control the overall operation of the vehicle control apparatus 100. The processor 150 may be implemented as at least one of an application specific integrated circuit (ASIC), a digital signal processor (DSP), programmable logic devices (PLD), field programmable gate arrays (FPGAs), a central processing unit (CPU), microcontrollers, or microprocessors, or any combination thereof.

The processor 150 may perform vehicle control depending on predetermined control logic such that the user (e.g., a driver, a passenger, and/or the like) that rides in the vehicle is able to take a rest while driving or is able to take a rest after parking. The rest may include reading, listening to the radio, listening to music, sleep (or deep sleep), and/or the like.

The processor 150 may determine whether the user is resting in the vehicle. The processor 150 may sense (or recognize) a state of the user who rides in the vehicle, using the camera 111, the brain wave sensor 112, and/or the like. The processor 150 may perform an analysis (e.g., a face feature analysis, a posture feature analysis, or the like) of the image captured by the camera 111 to determine whether the user is resting. Furthermore, the processor 150 may analyze the brain wave signal measured by the brain wave sensor 112 to determine whether the user is resting. If it is determined that the user is resting in the vehicle, the processor 150 may determine to enter an in-vehicle rest mode.

The processor 150 may determine whether a rest mode is selected based on data according to the user input received from the user interface 120. If it is determined that the rest mode is selected by the user, the processor 150 may determine to enter the rest mode after stopping. If it is determined to enter the rest mode after stopping, the processor 150 may recommend a resting place. The processor 150 may search for an available parking place given a current location and a driving route of the vehicle via a navigation device (not shown). The processor 150 may then recommend the found available parking place as a candidate resting place. The available parking place may be a resting place where the user is able to rest after parking the vehicle, i.e., a sleep shelter and/or a rest area.

The processor 150 may select any one of the recommended candidate resting places and may set the selected candidate resting place to a resting place. For example, the processor 150 may determine a resting place closest to the current location of the vehicle among resting places located on the driving route of the vehicle as a resting place. The processor 150 may determine an available parking place input by the user as a resting place. Furthermore, the processor 150 may set a resting place determined by the navigation device (not shown) to a destination. The processor 150 may determine whether the vehicle arrives at the resting place. If the vehicle arrives at the resting place, the processor 150 may determine to enter the in-vehicle rest mode. If it is determined to enter the in-vehicle rest mode, the processor 150 may enter the in-vehicle rest mode.

The processor 150 may recognize a gear selector position using the gear selector position sensor 115. The processor 150 may identify whether the recognized gear selector position is a park (P) stage. The processor 150 may identify a time when the gear selector position is maintained in the P stage (i.e., a P-stage maintenance time of the gear selector). The processor 150 may determine whether the P-stage maintenance time of the gear selector is greater than or equal to a first reference time. If it is determined that the P-stage maintenance time of the gear selector is greater than or equal to the first reference time, the processor 150 may enter a charging control mode. The first reference time may be predetermined by the system designer.

The processor 150 may recognize whether manipulation pedals, such as the accelerator pedal and the brake pedal, operate using the accelerator pedal position sensor 113 and the brake pedal position sensor 114. The processor 150 may determine whether non-operation times of the manipulation pedals are greater than or equal to a second reference time. In other words, the processor 150 may determine whether the non-operation time of the accelerator pedal is greater than or equal to the second reference time and the non-operation time of the brake pedal is greater than or equal to the second reference time. The second reference time may be predetermined by the system designer and may be different from or the same as the first reference time. If it is determined that the non-operation times of the accelerator pedal and the brake pedal are greater than or equal to the second reference time, the processor 150 may enter the charging control mode.

The processor 150 may recognize a seat angle using the seat angle sensor 116. The processor 150 may determine whether the recognized seat angle is greater than or equal to a first reference angle. The first reference angle may be predetermined by the system designer. If it is determined that the recognized seat angle is greater than or equal to the first reference angle, the processor 150 may enter the charging control mode.

When entering the charging control mode, the processor 150 may adjust an idle charging SOC, which is a criterion for determining the start and end of idle charging in the in-vehicle rest mode. The idle charging SOC may include an idle charging start SOC, which is a criterion for determining the start of idle charging, and an idle charging end SOC, which is a criterion for determining the end of idle charging.

The processor 150 may downwardly adjust the default idle charging start SOC to a first reference SOC. The first reference SOC may be determined at or above a critical low (CL) capable of affecting battery life and may be set to a CL starting point. The processor 150 may downwardly adjust the idle charging start SOC, thus reducing the number of engine on and off cycles.

Furthermore, the processor 150 may upwardly adjust the default idle charging end SOC to a second reference SOC. The processor 150 may upwardly adjust the idle charging end SOC to perform maximum charging when the engine is on, thus preventing the engine from being frequently on and off. The second reference SOC may be determined at or below a critical high (CH) capable of affecting battery life and may be set to a CH starting point.

The processor 150 may compare an SOC of a battery B with the first reference SOC. The processor 150 may determine whether to enter an idle charging mode based on the compared result. If it is determined that the SOC of the battery B is less than the first reference SOC, the processor 150 may enter the idle charging mode. The idle charging mode may refer to a function of charging the battery B while stopping.

The processor 150 may determine the maximum power available for charging based on the maximum power available for charging in the engine 10. At this time, the processor 150 may determine an engine speed with less sense of difference and torque with less booming noise when the engine 10 is on.

The processor 150 may determine a drive motor maximum power based on the engine speed. The processor 150 may determine a speed (or a drive motor speed) of the drive motor 40 from the engine speed. The processor 150 may determine a maximum torque at the determined speed of the drive motor 40 and may determine the drive motor maximum power based on the determined maximum torque. For example, because the drive motor speed is an engine speed, if transmission mounted electric device (TMED) 2 is applied to the vehicle, the processor 150 may determine the drive motor maximum power from the maximum torque at the drive motor speed.

The processor 150 may determine whether the maximum power available for charging is greater than the drive motor maximum power. The processor 150 may compare the maximum power available for charging with the drive motor maximum power.

If it is determined that the maximum power available for charging is greater than the drive motor maximum power, the processor 150 may determine power of the drive motor 40 (i.e., the drive motor power) as the drive motor maximum power. The MCU 142 may control the drive motor 40 to output maximum power under an instruction of the processor 150. The processor 150 may charge the battery B using the maximum power of the drive motor 40.

The processor 150 may determine power of the sub-motor 50 as a value obtained by subtracting the drive motor maximum power from the maximum power available for charging. The processor 150 may calculate a difference between the maximum power available for charging and the drive motor maximum power. The processor 150 may determine the calculated difference as sub-motor power. The MCU 142 may control the sub-motor 50 to output the determined sub-motor power depending on a control command of the processor 150. The processor 150 may charge the battery B using the power output from the sub-motor 50. In other words, the processor 150 may control the sub-motor 50 to assist the drive motor 40 to charge the battery B.

If it is determined that the maximum power available for charging is not greater than the drive motor maximum power, the processor 150 may determine the drive motor power as the maximum power available for charging. The processor 150 may control the drive motor 40 to output the maximum power available for charging. The processor 150 may charge the battery B using the maximum power available for charging, which is output from drive motor 40.

The processor 150 may determine the sub-motor power as “0”. In other words, the processor 150 may use only the drive motor 40 and may fail to use the sub-motor 50 to charge the battery B.

The processor 150 may determine whether an SOC of the battery B is greater than a second reference SOC. If it is determined that the SOC of the battery B is greater than the second reference SOC, the processor 150 may end charging control. Meanwhile, if it is determined that the SOC of the battery B is not greater than the second reference SOC, the processor 150 may maintain the charging control.

The processor 150 may perform the charging control and may determine whether a condition for releasing the in-vehicle rest mode (i.e., an in-vehicle rest mode release condition) is met. The processor 150 may obtain state information of the user using the camera 111, the brain wave sensor 112, and/or the like. The processor 150 may determine whether the user stops (or ends) a rest based on the obtained state information of the user. If it is determined that the user stops the rest, the processor 150 may determine to release the in-vehicle rest mode.

Furthermore, the processor 150 may identify whether a control command (or data) instructing to release the rest mode is received from the user interface 120. If it is identified that the control command instructing to release the rest mode is received from the user interface 120, the processor 150 may determine that the rest mode release is selected by the user. If it is determined that the in-vehicle rest mode release is selected by the user, the processor 150 may determine to release the in-vehicle rest mode.

The processor 150 may detect a seat angle using the seat angle sensor 116. The processor 150 may compare the detected seat angle with a previously detected seat angle to determine whether the seat angle is adjusted. If it is determined that the seat angle is adjusted, the processor 150 may compare the adjusted seat angle with a second reference angle. If it is determined that the seat angle is less than or equal to the second reference angle, the processor 150 may determine to release the in-vehicle rest mode.

The processor 150 may detect a brake pedal position using the brake pedal position sensor 114. The processor 150 may determine whether the brake pedal operates based on the detected brake pedal position. If it is determined that brake pedal operates, the processor 150 may determine to release the in-vehicle rest mode.

The processor 150 may determine whether the P stage of the gear selector is released using the gear selector position sensor 115. In other words, the processor 150 may determine whether the gear selector position switches from the P stage to another gear selector position (e.g., a drive (D) stage, a reverse (R) stage, or the like). If it is determined that the gear selector position switches from the P stage to the other gear selector position, the processor 150 may determine to release the in-vehicle rest mode.

If it is determined that the gear selector position switches from the P stage to the other gear selector position, the processor 150 may compensate for the charging power (or power) of the drive motor 40 using the maximum charging power of the sub-motor 50. The processor 150 may downwardly adjust the charging power of the drive motor 40 and may downwardly adjust the charging power of the engine 10. The processor 150 may perform battery charging using the sub-motor 50 and may guide the charging power the engine 10 to be “0”, i.e., guide the engine 10 to be off. If it is determined that the P stage of the gear selector is released, the processor 150 may determine whether the charging power of the drive motor 40 is “0”.

If it is determined that the brake pedal operates, the processor 150 may compensate for the charging power of the drive motor 40 using the maximum charging power of the sub-motor 50. The processor 150 may downwardly adjust the charging power of the drive motor 40 and may downwardly adjust the charging power of the engine 10. The processor 150 may determine whether the P stage of the gear selector is released. If it is determined that the P stage of the gear selector is released, the processor 150 may determine whether the charging power of the drive motor 40 is “0”.

If it is determined to release the in-vehicle rest mode, the processor 150 may downwardly adjust the charging power of the drive motor 40 and may downwardly adjust the charging power of an engine 10. If it is determined that the user stops the rest, if it is determined that the rest mode release is selected by the user, or if it is determined that the seat angle is less than or equal to the second reference angle, the processor 150 may downwardly adjust the charging power of the drive motor 40 and may downwardly adjust the charging power of an engine 10. The processor 150 may determine whether the P stage of the gear selector is released. If it is determined that the P stage of the gear selector is released, the processor 150 may determine whether the charging power of the drive motor 40 is “0”.

If it is determined that the charging power of the drive motor 40 is “0”, the processor 150 may release an engine clutch 30. If the engine clutch 30 is released, the processor 150 may allow the gear selector to be released from the P stage. The processor 150 may control a transmission 60 such that the P stage is able to be released after releasing the engine clutch 30.

If the charging power of the drive motor 40 is not “0”, the processor 150 may output a notification indicating that the release of the P stage of the gear selector is delayed. The processor 150 may output a notification in the form of visual information, audible information, tactile information, and/or the like.

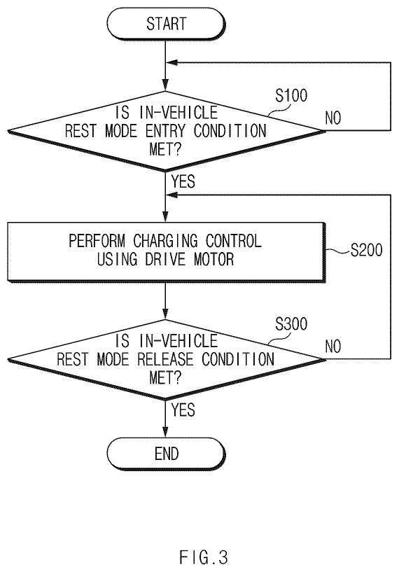

FIG. 3 is a flowchart illustrating a vehicle control method according to embodiments of the present disclosure.

In S100, a processor 150 of a vehicle control apparatus 100 may determine whether a condition for entering an in-vehicle rest mode (or an in-vehicle rest mode entry condition) is met (YES in S100). The processor 150 may determine whether the in-vehicle rest mode entry condition is met based on a user state detected by a detector 110 or a user input received from a user interface 120. Furthermore, the processor 150 may determine whether the in-vehicle rest mode entry condition is met based on vehicle information detected by the detector 110. The vehicle information may include a gear selector position, whether an accelerator pedal and a brake pedal operate, a seat angle, and/or the like.

If it is determined that the rest mode entry condition is met, in S200, the processor 150 may perform charging control using a drive motor 40. The processor 150 may enter an in-vehicle rest mode in a stop state. The processor 150 may charge a battery B using only the drive motor 40 in the in-vehicle rest mode or may charge the battery B using the drive motor 40 and a sub-motor 50 in the in-vehicle rest mode. The processor 150 may adjust the power (or charging power) of the drive motor 40 to charge the battery B. Furthermore, the processor 150 may perform the battery charging using the drive motor 40 and may adjust the power of the sub-motor 50 to execute battery charging.

In S300, the processor 150 may perform charging control and may determine whether a condition for releasing the in-vehicle rest mode (i.e., an in-vehicle rest mode release condition) is met (YES in S300). The processor 150 may determine whether the in-vehicle rest mode release condition is met based on a user state detected by the detector 110 or a user input received from the user interface 120. If it is determined that the in-vehicle rest mode release condition is met, the processor 150 may end the in-vehicle rest mode. If it is determined that the in-vehicle rest mode release condition is not met (NO in S300), the processor 150 may maintain the in-vehicle rest mode and may continue charging time optimization control. Furthermore, the processor 150 may determine whether the in-vehicle rest mode release condition is met based on vehicle information detected by the detector 110. The vehicle information may include a gear selector position, whether the brake pedal operates, a seat angle, and/or the like. If it is determined that the in-vehicle rest mode release condition is met, the processor 150 may release the charging control using the drive motor 40.

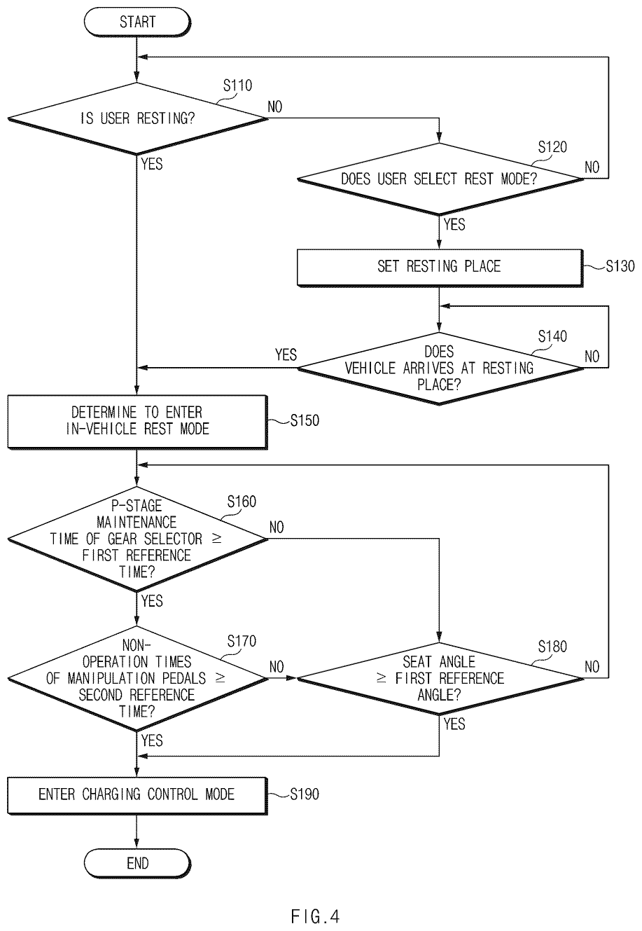

FIG. 4 is a flowchart illustrating a method for determining whether an in-vehicle rest mode entry condition is met according to embodiments of the present disclosure.

In S110, a processor 150 of a vehicle control apparatus 100 may determine whether a user that rides in a vehicle is resting based on state information of the user (YES in S110). The processor 150 may obtain the state information of the user (e.g., a driver, a passenger, or the like) using a detector 110, such as a camera 111 and/or a brain wave sensor 112 mounted on the vehicle. The processor 150 may determine whether the user is resting based on the obtained the state information of the user. For example, the processor 150 may analyze an image obtained by the camera 111 in the vehicle to determine whether the user is resting. Furthermore, the processor 150 may analyze a brain wave signal measured by the brain wave sensor 112 to determine whether the user is resting.

If it is determined that the user is not resting (NO in S110), in S120, the processor 150 may determine whether a rest mode is selected by the user while driving. The processor 150 may identify whether a control command (or data) instructing to enter the rest mode is received from a user interface 120. If it is identified that the control command instructing to enter the rest mode is received from the user interface 120, the processor 150 may determine that the rest mode is selected by the user (YES in S120). Meanwhile, if it is identified that the control command instructing to enter the rest mode is not received from the user interface 120 (NO in S120), the processor 150 may determine that the rest mode is not selected by the user. If it is determined that the rest mode is not selected by the user, the processor 150 may return to S110.

If it is determined that the rest mode is selected by the user, in S130, the processor 150 may set a resting place. The processor 150 may search for an available parking place given a current location and a driving route of the vehicle via a navigation device (not shown). The processor 150 may then recommend the found available parking place as a candidate resting place. The available parking place may be a resting place where the user is able to rest after parking the vehicle, i.e., a sleep shelter and/or a rest area. The processor 150 may select any one of the recommended candidate resting places and may set the selected candidate resting place to a resting place. For example, the processor 150 may determine a resting place closest to the current location of the vehicle among resting places located on the driving route of the vehicle as a resting place. The processor 150 may set a resting place selected by the user to a destination using the navigation device (not shown). Furthermore, the processor 150 may set the resting place to the destination based on the user input received from the user interface 120.

In S140, the processor 150 may determine whether the vehicle arrives at the resting place. The processor 150 may determine whether the vehicle arrives at the resting place using the navigation device (not shown). The navigation device (not shown) may calculate a current location of the vehicle using a signal transmitted from a satellite. The navigation device (not shown) may compare the calculated current location of the vehicle with a location of the resting place set to the destination to determine whether the vehicle arrives at the resting place. The navigation device (not shown) may transmit the result of determining whether the vehicle arrives at the resting place to the processor 150. The processor 150 may determine whether the vehicle arrives at the resting place based on the determined result transmitted from the navigation device (not shown).

If it is determined that the user is resting in S110 or if it is determined that the vehicle arrives at the resting place in S140 (YES in S140), in S150, the processor 150 may determine to enter an in-vehicle rest mode. If it is determined to enter the in-vehicle rest mode, the processor 150 may enter the in-vehicle rest mode.

If it is determined to enter the in-vehicle rest mode, in S160, the processor 150 may determine whether a P-stage maintenance time of a gear selector is greater than or equal to a predetermined first reference time. The processor 150 may recognize a gear selector position using a gear selector position sensor 115. The processor 150 may identify whether the gear selector position is a P stage and may identify a time when the gear selector maintains the P stage. The processor 150 may determine whether the P-stage (or parking stage) maintenance time of the gear selector is greater than or equal to the predetermined first reference time. The first reference time may be predetermined by a system designer.

If it is determined that the P-stage maintenance time of the gear selector is greater than or equal to the first reference time (YES in S160), in S170, the processor 150 may determine whether non-operation times of manipulation pedals are greater than or equal to a second reference time. The processor 150 may recognize whether the manipulation pedals, such as an accelerator pedal and a brake pedal, operate using an accelerator pedal position sensor 113 and a brake pedal position sensor 114. The processor 150 may determine whether the non-operation times of the accelerator pedal and the brake pedal are greater than or equal to the second reference time. In other words, the processor 150 may determine whether the non-operation time of the accelerator pedal is greater than or equal to the second reference time and the non-operation time of the brake pedal is greater than or equal to the second reference time (YES in S170). The second reference time may be predetermined by the system designer and may be different from or the same as the first reference time.

If it is determined that the P-stage maintenance time of the gear selector is not greater than or equal to the first reference time in S160 (NO in S160) or if it is determined that the non-operation times of the manipulation pedals are not greater than or equal to the second reference time in S170 (NO in S170), in S180, the processor 150 may determine whether a seat angle is greater than or equal to a predetermined first reference angle. The processor 150 may recognize a seat angle using a seat angle sensor 116. The seat angle may refer to an inner angle formed by a backrest and a cushion of a seat. The first reference angle may be predefined by the system designer.

If it is determined that the non-operation times of the manipulation pedals are greater than or equal to the second reference time in S170 (YES in S170) or if it is determined that the seat angle is greater than or equal to the first reference angle (YES in S180), in S190, the processor 150 may enter a charging control mode. If the seat angle is not greater than or equal to the first reference angle in S180, i.e., if it is determined that the seat angle is less than the first reference angle, the processor 150 may return to S160.

According to the above-mentioned embodiment, the present disclosure may additionally determine whether the vehicle control apparatus 100 enters the in-vehicle rest mode based on the gear selector position, whether the manipulation pedals operate, whether the seat angle is adjusted, and/or the like in the state in which it enters the in-vehicle rest mode. Thus, the present disclosure may more accurately recognize whether the in-vehicle rest mode is activated. As such, the present disclosure may minimize an engine driving time for battery charging when charging the battery using the engine 10 due to a lack of the SOC of the battery B in the in-vehicle rest mode. Thus, vibration and noise generated when the engine 10 is driven, which interfere with the resting of the passenger, may be minimized.

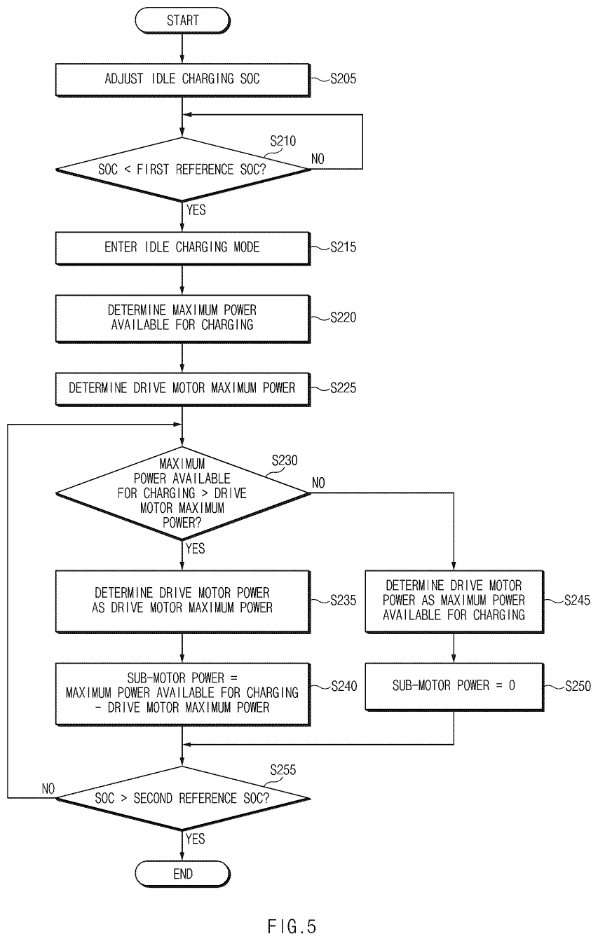

FIG. 5 is a flowchart illustrating a charging control method using a drive motor according to embodiments of the present disclosure.

In S205, a processor 150 may adjust an idle charging SOC, which is a criterion for determining the start and end of idle charging in an in-vehicle rest mode when entering a charging control mode. The idle charging SOC may include an idle charging start SOC, which is a criterion for determining the start of idle charging, and an idle charging end SOC, which is a criterion for determining the end of idle charging.

The processor 150 may downwardly adjust the default idle charging start SOC to a first reference SOC. The first reference SOC may be determined at or above a critical low (CL) capable of affecting battery life and may be set to a CL starting point. The processor 150 may downwardly adjust the idle charging start SOC, thus reducing the number of engine on and off cycles.

Furthermore, the processor 150 may upwardly adjust the default idle charging end SOC to a second reference SOC. The processor 150 may upwardly adjust the idle charging end SOC to perform maximum charging when the engine is on, thus preventing the engine from being frequently on and off. The second reference SOC may be determined at or below a critical high (CH) capable of affecting battery life and may be set to a CH starting point.

The processor 150 may determine whether an SOC of a battery B is less than the first reference SOC in S210. The processor 150 may compare the SOC of the battery B with the first reference SOC to determine whether idle charging starts based on the compared result.

If it is determined that the SOC of the battery B is less than the first reference SOC (YES in S210), in S215, the processor 150 may enter the idle charging mode. The idle charging mode may refer to a function of charging a battery B while stopping.

In S220, the processor 150 may determine a maximum power available for charging based on the maximum power available for charging in an engine 10. The processor 150 may determine an engine speed with less sense of difference and torque with less booming noise, when the engine 10 is on.

In S225, the processor 150 may determine a drive motor maximum power based on the engine speed. The processor 150 may determine a speed of a drive motor 40 (or a drive motor speed) from the engine speed. The processor 150 may determine a maximum torque at the determined speed of the drive motor 40 and may determine the drive motor maximum power based on the determined maximum torque. For example, because the drive motor speed is an engine speed, if transmission mounted electric device (TMED) 2 is applied to a vehicle, the processor 150 may determine the drive motor maximum power from the maximum torque at the drive motor speed.

In S230, the processor 150 may determine whether the maximum power available for charging is greater than the drive motor maximum power. The processor 150 may compare the maximum power available for charging with the drive motor maximum power.

if it is determined that the maximum power available for charging is greater than the drive motor maximum power (YES in S230), in S235, the processor 150 may determine the power of the drive motor 40 (i.e., the drive motor power) as the drive motor maximum power. An MCU 142 may control the drive motor 40 to output maximum power under an instruction of the processor 150. The processor 150 may charge the battery B using the maximum power of the drive motor 40.

In S240, the processor 150 may determine power of a sub-motor 50 as a value obtained by subtracting the drive motor maximum power from the maximum power available for charging. The processor 150 may calculate a difference between the maximum power available for charging and the drive motor maximum power. The processor 150 may determine the calculated difference as sub-motor power. The MCU 142 may control the sub-motor 50 to output the determined sub-motor power depending on a control command of the processor 150. The processor 150 may charge the battery B using the power output from the sub-motor 50. In other words, the processor 150 may control the sub-motor 50 to assist the drive motor 40 to charge the battery B.

If it is determined that the maximum power available for charging is not greater than the drive motor maximum power in S230 (NO in S230), in S245, the processor 150 may determine the drive motor power as the maximum power available for charging. The processor 150 may control the drive motor 40 to output the maximum power available for charging. The processor 150 may charge the battery B using the maximum power available for charging, which is output from drive motor 40.

In S250, the processor 150 may determine the sub-motor power as “0”. In other words, the processor 150 may use only the drive motor 40 and may fail to use the sub-motor 50 to charge the battery B.

After S240 or S250, in S255, the processor 150 may determine whether the SOC of the battery B is greater than a second reference SOC. If it is determined that the SOC of the battery B is greater than the second reference SOC (YES in S255), the processor 150 may end charging control. Meanwhile, if it is determined that the SOC of the battery B is not greater than the second reference SOC (NO in S255), the processor 150 may return to S230.

Previously, it took about 5 minutes to charge the SOC of the battery B from 30% to 90% using only the sub-motor 50 when the battery is charged while stopping. However, according to the above-mentioned embodiment, the present disclosure may charge the battery B using the drive motor 40 to decrease a time required to charge the SOC of the battery B from 30% to 90% by about 1 minute.

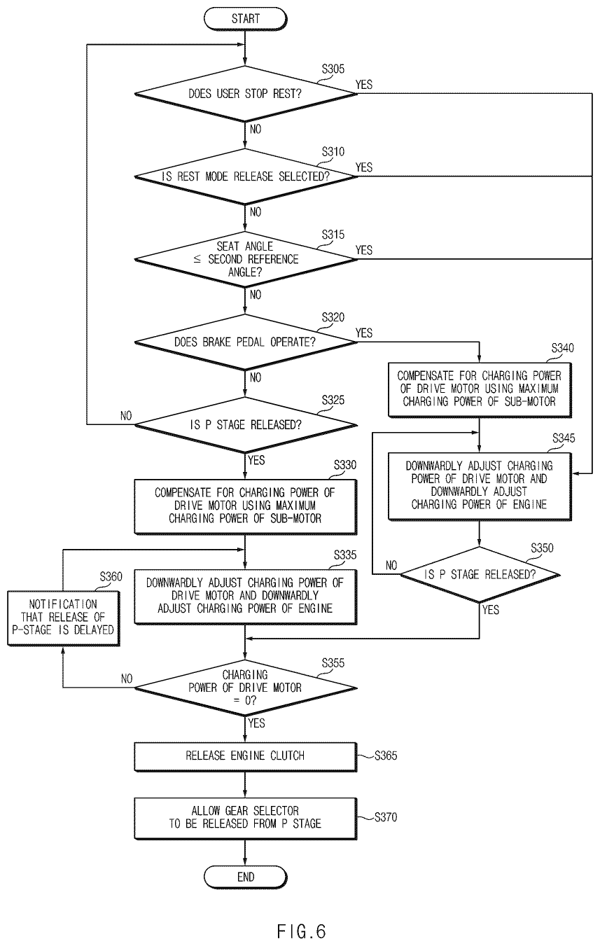

FIG. 6 is a flowchart illustrating a charging control release method using a drive motor according to embodiments of the present disclosure.

In S305, a processor 150 may determine whether a user stops a rest based on state information of the user. The processor 150 may obtain the state information of the user using a camera 111, a brain wave sensor 112, and/or the like. The processor 150 may determine whether the user stops (or ends) a rest based on the obtained the state information of the user.

If it is determined that the user does not stop the rest (NO in S305), in S310, the processor 150 may determine whether rest mode release is selected by the user. The processor 150 may identify whether a control command (or data) instructing to release a rest mode is received from a user interface 120. If it is identified that the control command instructing to release the rest mode is received from the user interface 120 (YES in S310), the processor 150 may determine that the rest mode release is selected by the user. Meanwhile, if it is identified that the control command instructing to release the rest mode is not received from the user interface 120 (NO in S310), the processor 150 may determine that the rest mode release is not selected by the user.

If it is determined that the rest mode release is not selected by the user, in S315, the processor 150 may determine whether a seat angle is less than or equal to a predetermined second reference angle. The processor 150 may detect a seat angle using a seat angle sensor 116. The processor 150 may compare the detected seat angle with a previously detected seat angle to determine whether the seat angle is adjusted. If it is determined that the seat angle is adjusted, the processor 150 may compare the adjusted seat angle with the second reference angle.

If it is determined that the seat angle is not less than or equal to the second reference angle (NO in S315), in S320, the processor 150 may determine whether a brake pedal operates. The processor 150 may detect a brake pedal position using a brake pedal position sensor 114. The processor 150 may determine whether the brake pedal operates based on the detected brake pedal position.

If it is determined that the brake pedal does not operate (NO in S320), in S325, the processor 150 may determine whether a P stage of a gear selector is released. If it is determined that the brake pedal does not operate, the processor 150 may determine whether the gear selector position switches from the P stage to another gear selector position (e.g., a D stage, an R stage, or the like). If it is determined that the gear selector position switches from the P stage to the other gear selector position (YES in S325), the processor 150 may determine that the P stage of the gear selector is released. If it is determined that the gear selector position does not switch from the P stage to the other gear selector position (NO in S325), the processor 150 may determine that the P stage of the gear selector is not released. If it is determined that the P stage of the gear selector is not released, the processor 150 may return to S305.

If it is determined that the P stage of the gear selector is released, in S330, the processor 150 may compensate for charging power of a drive motor 40 using the maximum charging power of a sub-motor 50.

In S335, the processor 150 may downwardly adjust charging power of the drive motor 40 and may downwardly adjust charging power of an engine 10. The processor 150 may perform battery charging using the sub-motor 50 and may guide the charging power the engine 10 to be “0”, i.e., guide the engine 10 to be off.

If it is determined that the brake pedal operates (YES in S320), in S340, the processor 150 may compensate for the charging power of the drive motor 40 using the maximum charging power of the sub-motor 50. As a result, when the P stage of the gear selector is released, the processor 150 may quickly allow the power of the drive motor 40 to be “0”.

In S345, the processor 150 may downwardly adjust charging power of the drive motor 40 and may downwardly adjust charging power of the engine 10.

Furthermore, if it is determined that the user stops the rest (YES in S305), if it is determined that the rest mode release is selected by the user (YES in S310), or if it is determined that the seat angle is less than or equal to the second reference angle (YES in S315), in S345, the processor 150 may downwardly adjust the charging power of the drive motor 40 and may downwardly adjust the charging power of the engine 10.

In S350, the processor 150 may determine whether the P stage of the gear selector is released after S345.

After S335, or if it is determined that the P stage of the gear selector is released (YES in S350), in S355, the processor 150 may determine whether the charging power of the drive motor 40 is “0”.

If the charging power of the drive motor 40 is not “0” (NO in S355), in S360, the processor 150 may output a notification indicating that the release of the P stage of the gear selector is delayed. The processor 150 may output a notification in the form of text, an image, a sound, and/or the like.

If it is determined that the charging power of the drive motor 40 is “0” (YES in S355), in S365, the processor 150 may release an engine clutch 30.

If the engine clutch 30 is released, in S370, the processor 150 may allow the gear selector to be released from the P stage. The processor 150 may control a transmission 60 such that the P stage is able to be released after releasing the engine clutch 30.

Thereafter, when entering a charging control mode, the processor 150 may restore the adjusted idle charging SOC. The processor 150 may return an idle charging start SOC and an idle charging end SOC to values before adjustment.

According to the above-mentioned embodiments, if the P stage of the gear selector is released, the present disclosure may stop battery charging using the drive motor 40 and may quickly downwardly adjust engine power and motor power to release the engine clutch 30. In this case, because there may be a limitation in engine power fluctuation, the present disclosure may charge the battery B to a maximum using the sub-motor 50 such that torque delivered to the engine clutch 30 is able to be removed.

Embodiments of the present disclosure may charge the battery using the drive motor, while the passenger is resting in the vehicle, thus optimizing a charging time.

Furthermore, embodiments of the present disclosure may control the vehicle to minimize an element which hinders the rest of the passenger in the vehicle, such that the passenger is able to safely and comfortably rest in the vehicle.

Furthermore, embodiments of the present disclosure may minimize idle charging to guide the passenger to rest, thus improving fuel efficiency.

Hereinabove, although the present disclosure has been described with reference to example embodiments and the accompanying drawings, the present disclosure is not limited thereto. The embodiments may be variously modified and altered by those of ordinary skill in the art to which the present disclosure pertains without departing from the spirit and scope of the present disclosure claimed in the following claims. Therefore, embodiments of the present disclosure are not intended to limit the technical spirit of the present disclosure but are provided only for the illustrative purpose. The scope of the present disclosure should be construed on the basis of the accompanying claims. All the technical ideas within the scope equivalent to the claims should be included in the scope of the present disclosure.

What is claimed is:

1. A vehicle control apparatus, comprising:
a detector configured to obtain data using sensors mounted on a vehicle; and
a processor connected to the detector,
wherein the processor is configured to
determine to enter an in-vehicle rest mode based on the data obtained by the detector,
enter the in-vehicle rest mode in a stop state, and
control charging of a battery using a drive motor in the in-vehicle rest mode.

2. The vehicle control apparatus of claim 1, wherein the processor is configured to:
obtain state information of a user that rides in the vehicle, using at least one of a camera or a brain wave sensor, or any combination thereof;
determine whether the user is resting based on the state information of the user; and
determine to enter the in-vehicle rest mode based on determining that the user is resting.

3. The vehicle control apparatus of claim 1, wherein the processor is configured to:
determine to enter a charging control mode based on at least one of whether an accelerator pedal and a brake pedal operate, a gear selector position, a seat angle, or any combination thereof after entering the in-vehicle rest mode.

4. The vehicle control apparatus of claim 1, wherein the processor is configured to:
enter an idle charging mode based on a state of charge (SOC) of the battery;
determine a maximum power available for charging based on maximum power available for charging in an engine in the idle charging mode; and
determine a drive motor maximum power based on a speed of the engine.

5. The vehicle control apparatus of claim 4, wherein the processor is configured to:
determine a power of the drive motor as the drive motor maximum power, if the maximum power available for charging is greater than the drive motor maximum power; and
determine a power of a sub-motor as a power difference between the maximum power available for charging and the drive motor maximum power.

6. The vehicle control apparatus of claim 5, wherein the processor is configured to:
determine the power of the drive motor as the maximum power available for charging, if the maximum power available for charging is not greater than the drive motor maximum power.

7. The vehicle control apparatus of claim 5, wherein the processor is configured to:
release a charging control mode based on at least one of state information of a user, whether a brake pedal operates, a gear selector position, or a seat angle, or any combination thereof.

8. The vehicle control apparatus of claim 7, wherein the processor is configured to:
compensate for a charging power of the drive motor using a maximum charging power of the sub-motor, if the gear selector position switches from a park (P) stage to another gear selector position;
downwardly adjust the charging power of the drive motor; and
release an engine clutch in response that the charging power of the drive motor reaches “0”.

9. The vehicle control apparatus of claim 8, wherein the processor is configured to:
downwardly adjust a charging power of the engine and stop the engine.

10. The vehicle control apparatus of claim 7, wherein the processor is configured to:
compensate for a charging power of the drive motor using a maximum charging power of the sub-motor, if the brake pedal operates.

11. A vehicle control method, comprising:
determining to enter an in-vehicle rest mode based on data obtained by a detector mounted on a vehicle;
entering the in-vehicle rest mode in a stop state; and
controlling charging of a battery using a drive motor in the in-vehicle rest mode.

12. The vehicle control method of claim 11, wherein determining to enter the in-vehicle rest mode includes:
obtaining state information of a user that rides in the vehicle, using at least one of a camera, a brain wave sensor, or any combination thereof;
determining whether the user is resting based on the state information of the user; and
determining to enter the in-vehicle rest mode based on determining that the user is resting.

13. The vehicle control method of claim 11, wherein entering the in-vehicle rest mode includes:
determining to enter a charging control mode based on at least one of whether an accelerator pedal and a brake pedal operate, a gear selector position, a seat angle, or any combination thereof, after entering the in-vehicle rest mode.

14. The vehicle control method of claim 11, wherein controlling the charging of the battery includes:
entering an idle charging mode based on a state of charge (SOC) of the battery;
determining a maximum power available for charging based on a maximum power available for charging in an engine in the idle charging mode; and
determining a drive motor maximum power based on a speed of the engine.

15. The vehicle control method of claim 14, wherein controlling the charging of the battery includes:
determining a power of the drive motor as the drive motor maximum power, if the maximum power available for charging is greater than the drive motor maximum power; and
determining a power of a sub-motor as a power difference between the maximum power available for charging and the drive motor maximum power.

16. The vehicle control method of claim 15, wherein controlling the charging of the battery includes:
determining the power of the drive motor as the maximum power available for charging, if the maximum power available for charging is not greater than the drive motor maximum power.

17. The vehicle control method of claim 16, further comprising:
releasing a charging control mode based on at least one of state information of a user, whether a brake pedal operates, a gear selector position, a seat angle, or any combination thereof.

18. The vehicle control method of claim 17, wherein releasing the charging control mode includes:
compensating for a charging power of the drive motor using a maximum charging power of the sub-motor, if the gear selector position switches from a P stage to another gear selector position;
downwardly adjusting the charging power of the drive motor; and
releasing an engine clutch in response that the charging power of the drive motor reaches “0”.

19. The vehicle control method of claim 18, wherein releasing the charging control mode further includes:
downwardly adjusting a charging power of the engine and stopping the engine.

20. The vehicle control method of claim 17, wherein releasing the charging control mode includes:
compensating for a charging power of the drive motor using a maximum charging power of the sub-motor, if the brake pedal operates.
